(19) United States
(12) Patent Application Publication
(10) Pub. No.: US 2011/0208491 A1
(43) Pub. Date: Aug. 25, 2011

(54) APPARATUS AND METHOD FOR ITERATIVE SIMULATION OF AN OPERATION OF A DEVICE

(76) Inventors: Stefan Ast, Munchen (DE); Thomas Birkhölzer, Radolfzell (DE); Christoph Dickmann, Nurnberg (DE); Wolfgang Fietz, Erlangen (DE); Júrgen Vaupel, Weisendorf (DE)

(21) Appl. No.: 12/709,537

(22) Filed: Feb. 22, 2010

(51) Int. Cl. G06F 17/10; G06G 7/62

(52) U.S. Cl. 703/2; 703/20

(57) ABSTRACT

A method and a respective apparatus for simulating a behaviour of a device does not have to change the mode of operation of the device. Furthermore it is possible to simulate improvement strategy step-wise and therefore calculate an impact of a process improvement project. Therefore an iterative simulation procedure is provided, which may find application in process improvement, such as software engineering process improvement, as well as optimization of performance parameters of devices and machines.

### TECHNICAL FIELD

The present invention is directed to an apparatus for improvement of performance parameters and enhancement of reliability of a machine or a device and is especially directed to an apparatus for iterative simulation of an operation of a machine or a device. The present invention is furthermore directed to a respective method for iteratively simulating an operation of a device as well as a computer program being adapted to perform said method and a data carrier, which stores a respective computer program. The present invention furthermore provides an apparatus for evaluating process performance parameters and especially provides an apparatus for iterative simulation of at least one process improvement project.

### BACKGROUND

Machines and devices typically comprise a variety of components, which interact for providing certain functionality. Said machines and devices may be operated in sensitive environments, for instance a power plant. It is therefore required that said devices and machines operate fault robust and reliable. One single failure of a specific component being comprised in a sensitive machine may lead to several other failures, damages and even a dysfunction of a complete system. It can therefore be of special importance to simulate the operation and the provision of certain functionality for assuring that requested functionality is provided without any difficulty.

Because of an increased complexity of devices and machines and especially of a variety of comprised components being manufactured at different firms, it may not be possible for a technician to evaluate the functioning of said devices and machines manually. Therefore several approaches are known for reading out certain parameters of a machine and furthermore to evaluate them according to provided metrics. This can be performed by manually connecting an evaluation unit with a control unit, for instance of a car, and requesting or measuring certain status parameters.

It may be the case that a device has to be improved according to an improvement strategy comprising several improvement actions. It can be necessary to not only evaluate the impact of each of the single improvement actions, but to apply several improvement actions as a whole and determining the overall output of the application of said improvement actions. Said evaluations can be very time consuming and labour-intense. In case improvement actions are performed manually it may be the case that unreliable results are delivered because of a fault of a technician.

Because the devices and machines, which have to be evaluated, may operate in sensitive infrastructures it may not be feasible to perform test runs on said devices and machines, as they may have to be switched-off for accomplishing test runs. Furthermore, it may not be possible to switch-off said devices and machines as they are operated for instance in an assembly line, which would result in a total stand still of said assembly line. Furthermore, it is possible that an evaluation of a provided functionality is required as regards processes. It may therefore be required to simulate an operation of control commands, which controls said process.

Control commands often replace hardware in realizing much of the functionality provided by complex systems, e.g. in the medical device industry. The increased complexity of software products, distributed production processes and globally operating organizations lead to higher risks for failures and interruptions during software development. Planning, streamlining, managing and controlling localized or distributed software production are essential tasks of companies that build much of their business on the creation or integration of software.

The control of such a system, i.e. the management of a software organization, requires carefully balanced strategies instead of simple recipes. The various activities of software production depend on each other and form a complex system of relations and dynamics. The experience from promoting software engineering practices often reveals an insufficient consideration or appreciation of the overall system behaviour and complexity by stakeholders and practitioners: Although the single mechanisms seem to be simple and obvious, the overall effects of actions could not easily be predicted because of the number, non-linearity, and time-dependency of the underlying factors. Limited, local optimizations result in unexpected and even counterintuitive overall outcomes.

Interactive simulation is a known method to build and enhance the comprehension of complex systems by experimenting and especially experimenting with different scenarios. In this case, it can help to build a management understanding of complex software development and of potential effects of certain strategic decisions. This necessitates that, within the simulation, software development processes are related to goals in a way that improvements or changes to development conditions are reflected in characteristics of the organization's overall performance and goal achievement.

Further known approaches provide metrics for evaluating process improvements, for instance in the domain of software engineering. One of these approaches is the so-called capability maturity model integration, also referred to as CMMI.

Commonly known methods, especially in the domain of evaluating and improving the functioning of devices and machines are typically performed manually, which results in enhanced labour. Said labour may be prone to errors, which results in unreliable output. Commonly known methods do not provide a solution to dynamic scenarios in which conditions change and one simulation step depends on results of a former simulation step. It is therefore required to provide an approach for simulating a device according to a flexible and fault robust simulation procedure. Generally an approach is required, which allows for measuring and evaluating performance parameters without having to switch off a device, which has to be evaluated.

### SUMMARY

According to various embodiments, an apparatus for iterative simulation of an operation of a device can be provided.

According to an embodiment, an apparatus for iterative simulation of an operation of a device, may comprise: —a simulation unit for transforming at least one provided input parameter into at least one output parameter by applying a predefined set of rules, said set of rules describing a functionality of said device; and—a simulation control unit for controlling said simulation unit by providing at least one input parameter to said simulation unit as a function of at least one output parameter generated by said simulation unit.

According to a further embodiment of the apparatus, the set of rules can be formed according to at least one of a group of device description techniques, the group consisting of: a formal model, an algorithm, a differential equation, a device specification, a diagram, and an alphanumerical rule description technique. According to a further embodiment of the apparatus, the set of rules can be adapted by stored device configuration parameters. According to a further embodiment of the apparatus, at least one of a group of parameters can be evaluated by a parameter evaluation metric, the group consisting of: the at least one input parameter and the at least one output parameter. According to a further embodiment of the apparatus, transforming at least one provided input parameter into at least one output parameter can be performed as a function of the evaluation of parameters. According to a further embodiment of the apparatus, the parameter evaluation metric can be adapted as a function of the at least one output parameter. According to a further embodiment of the apparatus, the at least one input parameter and the at least one output parameter may comprise alphanumerical values. According to a further embodiment of the apparatus, the at least one input parameter and the at least one output parameter can be weighted for indicating a probability of their occurrence. According to a further embodiment of the apparatus, the at least one input parameter can be stored in an input parameter provision unit. According to a further embodiment of the apparatus, the at least one output parameter can be provided to a post processing unit for performing further operations on the at least one output parameter. According to a further embodiment of the apparatus, the at least one input parameter can be selected from a variety of provided input parameters by an input parameter selection unit.

According to a further embodiment of the apparatus, the set of rules may describe at least one of a group of dependencies, the group consisting of: a temporal dependency, a structural dependency, a logical dependency, a dependency between at least two parameter transformation steps, a dependency between at least two units of the device, a dependency between at least two activities of a process definition, and a dependency between at least two parameters.

According to another embodiment, an apparatus for iterative simulation of at least one process improvement project, may comprise—a model unit for transforming at least one provided model input into at least one model output by applying a predefined model configuration, the model configuration describing a process improvement project context; and—a model control unit, being connected with the model unit, for controlling the model unit by providing at least one model input to the model unit as a function of at least one model output generated by the model unit.

According to a further embodiment of the apparatus, transforming at least one provided model input into at least one model output can be performed according to the at least one process improvement project by a transformation unit.

According to yet another embodiment, a method for iteratively simulating an operation of a device, especially for operating the apparatus as described above, may comprise the steps of: transforming at least one provided input parameter into at least one output parameter by applying a predefined set of rules using a simulation unit, the set of rules describing a functionality of the device; and—controlling the simulation unit by providing at least one input parameter to the simulation unit as a function of at least one output parameter generated by the simulation unit.

According to yet another embodiment, a computer program can be adapted to perform the method as described above on a computer.

According to yet another embodiment, a data carrier may store a computer program as described above.

### BRIEF DESCRIPTION OF THE DRAWINGS

FIG. 1 shows a block diagram of an apparatus for iterative simulation of an operation of a device according to an embodiment;

FIG. 2 shows a detailed block diagram of an apparatus for iterative simulation of an operation of a device according to an embodiment;

FIG. 3 shows a flow diagram of a method for iteratively simulating an operation of a device according to an embodiment;

FIG. 4 shows a detailed flow diagram of a method for iteratively simulating an operation of a device according to an embodiment; and

FIG. 5 shows an apparatus for iterative simulation of at least one process improvement project according to an embodiment.

### DETAILED DESCRIPTION

According to various embodiments, an apparatus for iterative simulation of an operation of a device can be provided, comprising:

A simulation unit for transforming at least one provided input parameter into at least one output parameter for applying a predefined set of rules, said set of rules describing a functionality of said device; and

a simulation control unit for controlling said simulation unit by providing at least one input parameter to said simulation unit as a function of at least one output parameter generated by said simulation unit.

An iterative simulation may comprise several repeated steps performed by the simulation unit and/or the simulation control unit. It may therefore be the case that the simulation unit performs several steps and after said steps are performed the simulation control unit performs several further steps or that the simulation unit performs one single step and after that the simulation control unit performs one further single step and operates the simulation unit for a repeated accomplishment of a step. It may therefore be of advantage that the simulation unit calculates an output parameter, which is then provided to the simulation control unit and vice versa. The simulation control unit is designed to calculate a further output parameter based on the input parameter, which is formed by the former output parameter of the simulation unit. The output parameter calculated by the simulation control unit may furthermore again represent the input parameter of the simulation unit.

Hence a calculation of input parameters and output parameters is established by iterative performance of calculations of the simulation unit and the simulation control unit. In a first iteration the input parameter of the simulation unit may be provided by a storage device and/or a data base. It may furthermore be possible to provide said input parameters manually.

In further iterations it can be possible that input parameters and/or output parameters are provided by at least one of the simulation unit, the simulation control unit and/or a storage device. Hence, it may be the case that a first part of input parameters is provided by said storage device and that a second part of input parameters is provided by either the simulation unit or the simulation control unit.

An operation of a device can be simulated by a predefined set of rules, the predefined set of rules modelling behaviour and/or a functionality of the device. Furthermore, it may be possible that said device can be simulated by a model, which reflects real world settings, such as an environment, in which the device is operated. Said model may be formed according to an architecture diagram of said device. Said set of rules may for instance describe a functionality of said device by a number of mathematical formulas. Such a mathematical formula may for instance be a differential equation.

A functionality of said device may furthermore be described by a set of diagrams, the set of diagrams modelling several states, which characterize said device during the simulation process. The device may be designed to provide a specific functionality in a real world scenario.

For simulating said device the set of rules can be adapted according to provided configuration parameters. Hence the set of rules can be changed in every iterative simulation step being performed by the provided apparatus. For receiving configuration parameters the simulation unit may request said configuration parameter from a storage device and/or the simulation unit is designed to adapt said set of rules according to a received output parameter. Said received output parameter may be provided by the simulation control unit. It may therefore be the case that the predefined set of rules performs according to a first set of configuration parameters and in a further iteration performs according to a further set of configuration parameters. The configuration parameters may reflect real world settings, such as an environment the device is operated in or the configuration parameters may describe a set of resources said device may access.

It may furthermore be of advantage that said set of rules describes at least one dependency between activities, which have to be performed by said device. Said activities may for instance comprise calculation steps, which have to be performed by said device. Hence, said set of rules may describe a process definition, the process definition comprising several activities. An activity can be accomplished by an actor, which again has several features. It may therefore be of advantage that said set of rules describes an organizational environment along with process definitions and an organizational structure.

A transformation of at least one provided input parameter into at least one output parameter can be conducted by calculation steps or other steps being described according to a device specification. One can control said simulation unit by providing at least one input parameter to said simulation unit as a function of at least one output parameter. Generally, the provision parameters to the simulation unit and/or the simulation control unit is not restricted to the transforming of at least one provided input parameter into at least one output parameter or to generating at least one output parameter as a function of at least one input parameter. It may be useful to provide further input and/or output parameters by further units or by storage devices.

The set of rules may be accessed by the simulation unit as well as by the simulation control unit. Hence, both the simulation unit as well as the simulation control unit can be operated by the same set of rules. It may furthermore be of advantage to provide separate set of rules for operation of the simulation unit and a further separate set of rules for operation of the simulation control unit. The same holds for configuration parameters, which can be used for configuring the first set of rules and/or configuring the second or further set of rules. The iterative simulation of the operation of the device may for instance be accomplished by evaluating at least one of the output parameters. The output parameters can therefore be made persistent in a storage device or can be output to a further processing unit or a user.

In an embodiment of the apparatus, said set of rules is formed according to at least one of a group of device description techniques, said group comprising: a formal model, an algorithm, a differential equation, a device specification, a diagram and an alphanumerical rule description technique.

This has the advantage that said set of rules can be described by a variety of description techniques and that furthermore existing set of rules can be reused.

In yet a further embodiment of the apparatus, said set of rules can be adapted by stored device configuration parameters.

This has the advantage that said set of rules can be adapted for each iteration step and therefore the simulation control can be performed in a flexible way.

In yet a further embodiment of the apparatus, at least one of a group of parameters can be evaluated by a parameter evaluation metric, said group comprising: said at least one input parameter and said at least one output parameter.

This has the advantage that both qualitative and quantitative statements can be made about the simulation of the operation of the device.

In yet a further embodiment of the apparatus, transforming at least one provided input parameter into at least one output parameter is performed as a function of said evaluation of parameters.

This has the advantage that the calculation steps for generating input and output parameters can be dynamically adapted at run time. Hence, evaluation results can be considered for applying appropriate transformation steps.

In yet a further embodiment of the apparatus, said parameter evaluation metric is adapted as a function of said at least one output parameter.

This has the advantage that the evaluation metric can be fine tuned or can be changed in the case of certain expected output parameters are provided.

In yet a further embodiment of the apparatus, said at least one input parameter and said at least one output parameter comprise alphanumerical values.

This has the advantage that said at least one input parameter and said at least one output parameter may comprise attribute-value parameters.

In yet a further embodiment of the apparatus, said at least one input parameter and said at least one output parameter are weighted for indicating a probability of their occurrence.

This has the advantage that the simulation can also consider how likely an input parameter or an output parameter occurs during the simulation process.

In yet a further embodiment of the apparatus, said at least one input parameter is stored in an input parameter provision unit.

This has the advantage that, for instance in a first iteration, the input parameter can be provided by communication with an input parameter provision unit, such as a storage unit.

In yet a further embodiment of the apparatus, said at least one output parameter is provided to a post processing unit for performing further operations on said at least one output parameter.

This has the advantage that said at least one output parameter can be provided to a further system for analysis of the output parameter and/or for formatting said at least one output parameter.

In yet a further embodiment of the apparatus, said at least one input parameter is selected from a variety of provided input parameters by an input parameter selection unit.

This has the advantage that not all input parameters have to be provided, but a filtered selection can be provided.

In yet a further embodiment of the apparatus, said set of rules describes at least one of a group of dependencies, said group comprising: a temporal dependency, a structural dependency, a logical dependency, a dependency between at least two parameter transformation steps, a dependency between at least two units of said device, a dependency between at least two activities of a process definition and a dependency between at least two parameters.

This has the advantage that said set of rules can describe a structural architecture of said device, a process diagram and/or an organizational diagram.

According to other embodiments, an apparatus for iterative simulation of at least one process improvement project can be provided, comprising:

a model unit for transforming at least one provided model input into at least one model output by applying a predefined model configuration, said model configuration describing a process improvement project context; and
a model control unit, being connected with said model unit, for controlling said model unit by providing at least one model input to said model unit as a function of at least one model output generated by said model unit.

Transforming at least one provided model input into at least one model output may be performed according to said at least one process improvement project by a transformation unit.

According to other embodiments, a method for iteratively simulating an operation of a device, especially for operating at least one of the afore-mentioned apparatus, may comprise the steps of:

transforming at least one provided input parameter into at least one output parameter by applying a predefined set of rules using a simulation unit, said set of rules describing a functionality of said device; and
controlling said simulation unit by providing at least one input parameter to said simulation unit as a function of at least one output parameter generated by said simulation unit.

According to other embodiments, a computer program can be adapted to perform said method as well as a data carrier, which may store said computer program.

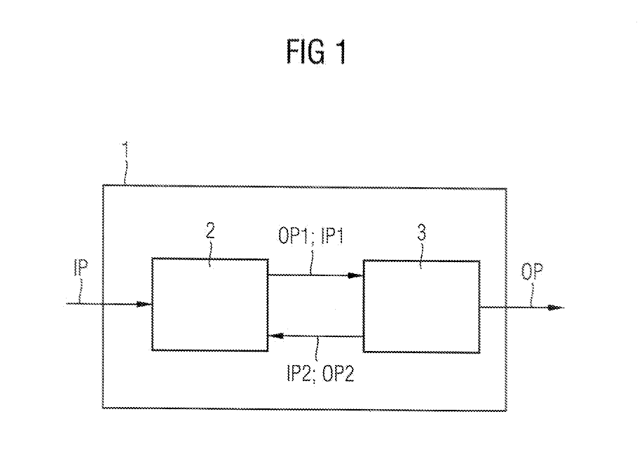

FIG. 1 shows a block diagram of an apparatus 1 for iterative simulation of an operation of a device. The apparatus 1 comprises:

a simulation unit 2 for transforming at least one provided input parameter IP, IP2 into at least one output parameter OP1 by applying a predefined set of rules, said set of rules describing a functionality of said device.

The apparatus 1 furthermore comprises a simulation control unit 3 for controlling said simulation unit 2 by providing at least one input parameter IP2 to said simulation unit 2 as a function of at least one output parameter OP1 generated by said simulation unit 2.

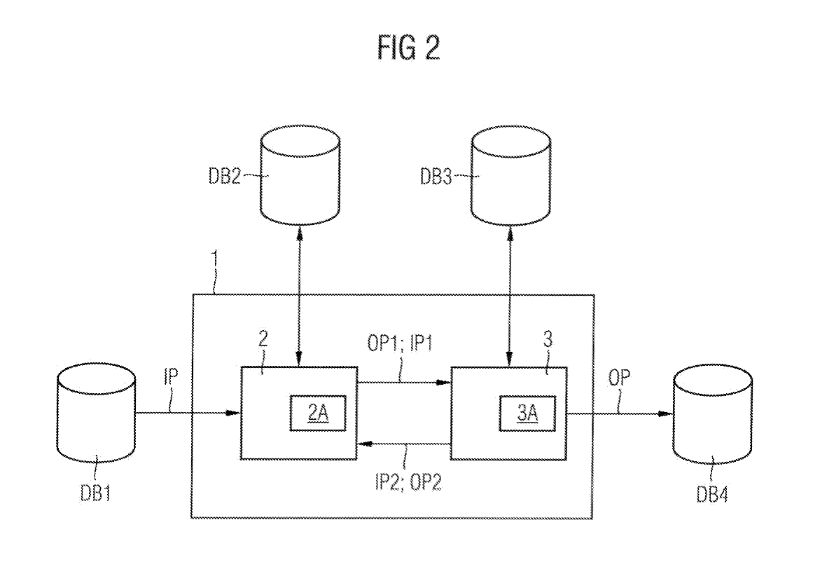

FIG. 2 shows a block diagram of an apparatus 1 for iterative simulation of an operation of a device and differs from the apparatus 1 shown in FIG. 1 as follows:

In the present embodiment the apparatus 1 for iterative simulation of an operation of a device comprises and/or communicates with several storage units DB1, DB2, DB3, DB4 for storing at least one of the input parameters IP, IP1, IP2 and/or the output parameters OP, OP1, OP2. It may furthermore be the case that said parameters IP, IP1, IP2, OP, OP1, OP2 are provided by said storage devices DB1, DB2, DB3, DB4.

In the present embodiment of the apparatus 1 for iterative simulation of an operation of a device a first input parameter IP is requested from the storage device DB1 and is transmitted to the simulation unit 2. The simulation unit 2 transforms said input parameter IP into at least one output parameter OP1 and transmits said output parameter OP1 to the simulation control unit 3. Hence, the output parameter OP1 calculated by the simulation unit 2 serves as input parameter IP1 for the simulation control unit 3. The simulation control unit 3 calculates a further output parameter OP2 as a function of the input parameter IP1 being provided by the simulation unit 2. The calculated output parameter OP2 serves as input parameter IP2 for the simulation unit 2.

Hence an iterative simulation of an operation of a device is performed by passing input and output parameters between the simulation unit 2 and the simulation control unit 3. In each iterative simulation step the input parameter may be transformed into an output parameter and said output parameter may again serve as input parameter for the respectively other unit.

It may be of advantage to receive the predefined set of rules from a database, for instance the storage unit DB2. It may furthermore be of advantage to change the predefined set of rules in each step of the iterative simulation. Therefore configuration parameters can be provided by a storage unit, for instance storage unit DB2. Said configuration parameters can be designed to adapt the predefined set of rules according to real world settings and/or to adapt said set of rules as a function of input parameters and/or output parameters. It is possible that a certain requested input parameter is received by the simulation unit 2 and therefore a setting, which is described in said set of rules has to be changed. One may for instance detect by a certain input parameter that the device which has to be simulated does not function correctly. Hence, it can be required to change said set of rules in order to simulate a different behaviour of the device. It may also be the case that the operation of a device changes certain settings, which again have to be considered by said set of rules. For adapting the predefined set of rules one can for instance apply a model configuration unit 2A, which is designed to configure a model being described by the predefined set of rules.

The simulation control unit 3 may comprise a calculation unit 3A, which is designed to calculate at least one output parameter OP2 as a function of at least one input parameter IP1. Therefore it may be the case, that the simulation control unit 3 communicates a storage unit, for instance storage unit DB3, for receiving information on how to generate said output parameter OP2 and furthermore how to control the simulation unit 2. The calculation unit 3A may furthermore be designed to perform further output processing. Said further output processing may for instance comprise formatting of at least one output parameter OP, OP2.

In the present embodiment the simulation control unit 3 transmits at least one output parameter OP for instance to a storage device DB4. After the output parameter OP is calculated as a function of the input parameter IP, it is possible to determine whether the operation of the device is accomplished successfully, which means that the expected output parameter OP is calculated correctly as a function of the output parameter IP. Hence the device is simulated by the simulation unit 2 and the simulation control unit 3 without having to change the operation mode of the real world device.

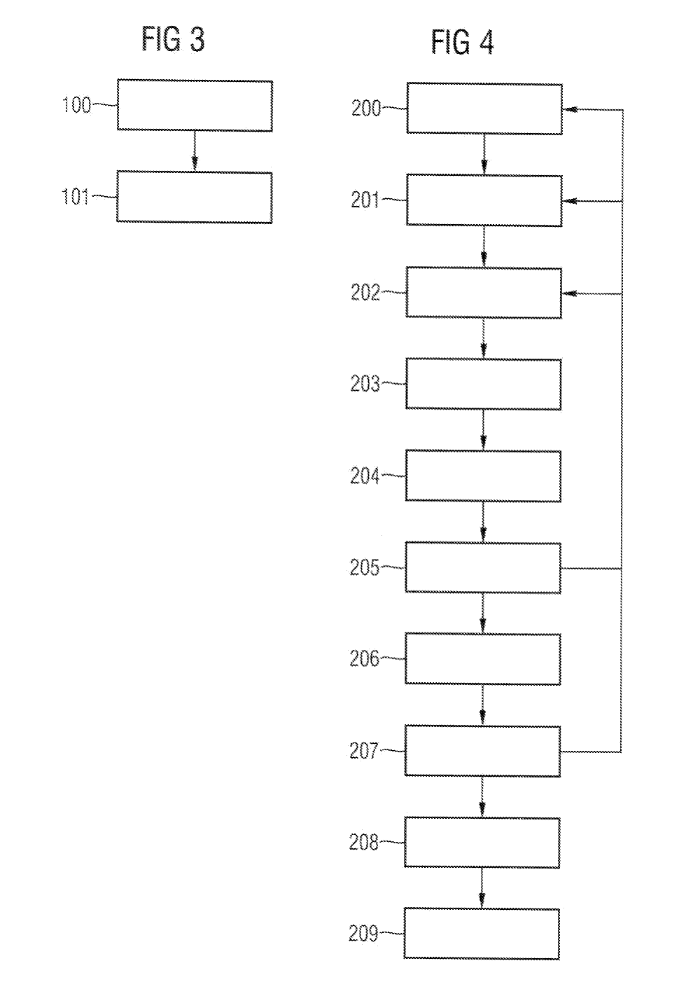

FIG. 3 describes a flow diagram of a method for iteratively simulating an operation of a device according to an embodiment. The method comprises the following steps:

Transforming 100 at least one provided input parameter into at least one output parameter by applying a predefined set of rules using a simulation unit, said set of rules describing a functionality of said device.

The method further comprises the step of controlling 101 said simulation unit by providing at least one input parameter to said simulation unit as a function of at least one output parameter generated by said simulation unit.

The afore-mentioned steps can be performed iteratively and/or in a different order and may comprise further substeps.

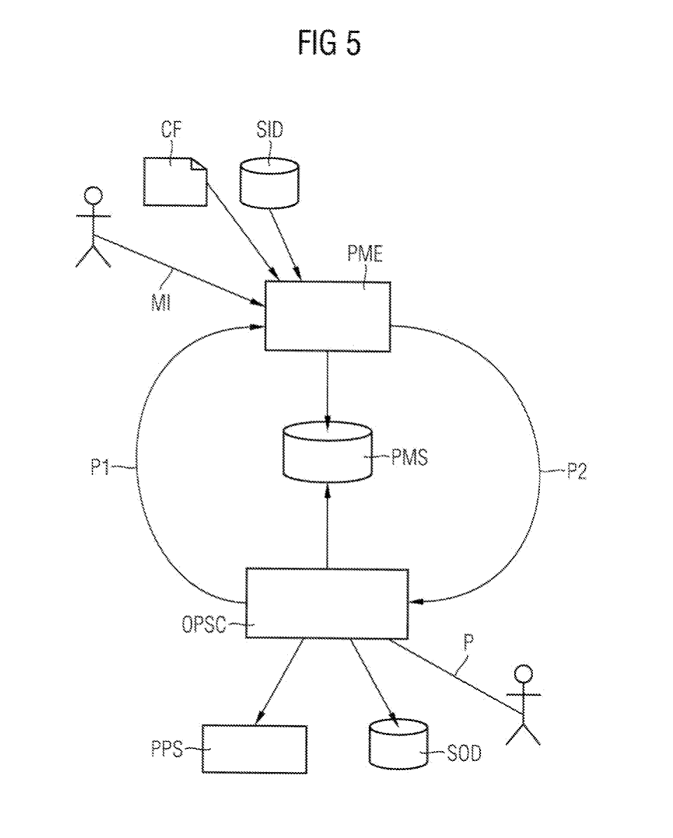

FIG. 4 shows a detailed flow diagram of a method for iteratively simulating an operation of a device according to an embodiment and comprises the following steps:

In a first step 200 a set of rules is created for instance by communication with a storage device or by dynamically deriving said set of rules. Said set of rules may for instance be performed by real world observations or by extraction of rules from a predefined set of rules. Furthermore it is possible to create a mathematical model in step 200, which describes the functionality and/or behaviour of the device. In one embodiment of the method for iteratively simulating an operation of a device such a mathematical model may comprise at least one differential equation.

In a further substep 201 the set of rules is configured. Configuring said set of rules in step 201 may for instance comprise fine tuning of the set of rules being provided in step 200. Said configuring may be performed by adaption of input parameters being applied on said set of rules being provided in step 200.

Furthermore at least one input parameter is provided in step 202. In further substeps a selection of input parameters is selected from a variety of potential input parameters from a data base. This may for instance comprise data base queries, for instance by an SQL expression for filtering the variety of input parameters and extraction of at least one input parameter. In further iterations providing the at least one input parameter in step 202 may be accomplished as a function of a generation step 205. It may therefore be the case that the generated output parameter in step 205 serves as input parameter, which is provided in step 202.

In a further step 203 the provided at least one input parameter is transmitted to a further unit, for instance to the simulation control unit, for generating an output parameter based on the provided input parameter being provided in step 202.

In step 204 generation rules are provided, which serve as a specification of how to transform the input parameters being provided in step 202 into at least one output parameter, which is performed in step 205. For further processing of the provided input parameters it is possible to determine a further mathematical model in step 204, which serves as basis for calculating the at least one output parameter in step 205. After the at least one output parameter is generated it is possible to accomplish further iterations, beginning from step 202 to 205 or beginning from step 201 to 205 or beginning from step 200 to step 205. Hence, it may be of advantage to provide a new set of rules for transforming input parameters into output parameters. It may further be useful to reuse the set of rules created in a former iteration and to configure them accordingly or to use the set of rules provided in any of the former iterations without configuring them. Hence, one can link from step 205 to step 202 and provide further input parameters for a next iteration step.

In one possible embodiment of the method for iteratively simulating an operation of a device the output parameters generated in step 205 are evaluated according to an evaluation metric. Therefore the evaluation metric is provided in step 206, which can be accomplished by communication with a storage device. In a further step 207 the provided evaluation metric of step 206 is applied on the generated output parameters of step 205. After evaluating the output parameters it is possible to proceed to any of step 200, step 201 or step 202. It is therefore possible to create a set of rules as a function of the provided evaluation result of the output parameters. Furthermore it is possible to configure said set of rules in dependence of the provided evaluation result. It may be useful to provide input parameters in step 202 as a function of the evaluation result being calculated in step 207.

In further steps 208 and 209 the at least one generated output parameter is provided, for instance in step 208, and further processing steps are accomplished in step 209.

The afore-mentioned steps can be performed iteratively and/or in a different order and may comprise further substeps.

FIG. 5 shows an apparatus for iterative batch simulation of at least one process improvement project according to an embodiment and comprises the following:

A model unit formed by a process model engine PME for transforming at least one provided model input MI, CF, SID, P1 into at least one model output P2 by applying a predefined model configuration, for instance provided by configuration file CF, said model configuration describing a process improvement project context. The apparatus as described in the present embodiment furthermore comprises a model control unit being formed by an output processing/simulation control unit OPSC, for controlling said model unit PME by providing at least one model input P1 to said model unit PME to a function of at least one model output P2 generated by said model unit PME.

For a more intuitive understanding the reference signs as used in the present FIG. 5 are summarized in the following table:

| Reference sign | Meaning |
|---|---|
| MI | Manual input, Needs UI |
| CF | Configuration file |
| SID | Stored input Data |
| PME | Process Model Engine |
| PMS | Process Model Storage |
| OPSC | Output processing/ |
| | Simulation control |
| PPS | Post-processing system |
| | Post-processing engine |
| SOD | Stored output data |

In the following a further embodiment of the apparatus for iterative simulation of at least one process improvement project is described.

The proposed process improvement simulation system according to an embodiment models general workflow independent process interdependencies quantitatively and does step-wise, repeated calculations of process model states and output based on the input values. The output at each step can be used for modifying the inputs for the next simulation step or is used by other systems.

The model may represent all processes that are defined for an organization, including their relations among each other and with metrics characterizing development and company procedures. This model can be left unchanged during a simulation, or it may change over the course of the simulation. The configurable process model gets input values that can be constant or variable over the different simulation steps. This input may characterize
a) the temporal behaviour and interdependencies of the processes in the organization, as modelled
b) process improvement decisions and actions as investments in improvement work.

The output may be defined by a set of values that are computed from the process states. The output may consist of the same or different values, so that changes in the organization's metrics can get reflected. The output processing uses the whole output and model configuration to
a) arrange and present output values to human users, e.g. for management review
b) process, e.g. analyze, transform or further calculate, or store values according to configurable rules.

There are variants of the overall process improvement simulation system where
a) input values are received by other systems, e.g. a project management system or enterprise management software
b) the model, i.e. the organisation's set of processes, is changed by user input or by input from the organization's process definition and maintenance systems
c) output values are sent to other systems as input or for storage.

As an additional feature, all parameters and variables can be defined as intervals to reflect the inherent uncertainty. In this case, all computations are based on interval analysis.

What is claimed is:

1. An apparatus for iterative simulation of an operation of a device, comprising:
a simulation unit operable to transform at least one provided input parameter into at least one output parameter by applying a predefined set of rules, said set of rules describing a functionality of said device; and
a simulation control unit operable to control said simulation unit by providing at least one input parameter to said simulation unit as a function of at least one output parameter generated by said simulation unit.

2. The apparatus according to claim 1, wherein said set of rules is formed according to at least one device description technique from a group of device description techniques, said group consisting of a formal model, an algorithm, a differential equation, a device specification, a diagram, and an alphanumerical rule description technique.

3. The apparatus according to claim 1, wherein said set of rules can be adapted by stored device configuration parameters.

4. The apparatus according to claim 1, wherein at least one parameter from a group of parameters can be evaluated by a parameter evaluation metric, said group consisting of said at least one input parameter and said at least one output parameter.

5. The apparatus according to claim 4, wherein transforming at least one provided input parameter into at least one output parameter is performed as a function of said evaluation of parameters.

6. The apparatus according to claim 4, wherein said parameter evaluation metric is adapted as a function of said at least one output parameter.

7. The apparatus according to claim 1, wherein said at least one input parameter and said at least one output parameter comprise alphanumerical values.

8. The apparatus according to claim 1, wherein said at least one input parameter and said at least one output parameter are weighted for indicating a probability of their occurrence.

9. The apparatus according to claim 1, wherein said at least one input parameter is stored in an input parameter provision unit.

10. The apparatus according to claim 1, wherein said at least one output parameter is provided to a post processing unit for performing further operations on said at least one output parameter.

11. The apparatus according to claim 1, wherein said at least one input parameter is selected from a variety of provided input parameters by an input parameter selection unit.

12. The apparatus according to claim 1, wherein said set of rules describes at least one dependency from a group of dependencies, said group consisting of a temporal dependency, a structural dependency, a logical dependency, a dependency between at least two parameter transformation steps, a dependency between at least two units of said device, a dependency between at least two activities of a process definition, and a dependency between at least two parameters.

13. An apparatus for iterative simulation of at least one process improvement project, comprising:
a model unit operable to transform at least one provided model input into at least one model output by applying a predefined model configuration, said model configuration describing a process improvement project context; and
a model control unit, being connected with said model unit, and operable to control said model unit by providing at least one model input to said model unit as a function of at least one model output generated by said model unit.

14. The apparatus according to claim 13, wherein transforming at least one provided model input into at least one model output is performed according to said at least one process improvement project by a transformation unit.

15. A method for iteratively simulating an operation of a device comprising the steps of:
transforming at least one provided input parameter into at least one output parameter by applying a predefined set of rules using a simulation unit, said set of rules describing a functionality of said device; and
controlling said simulation unit by providing at least one input parameter to said simulation unit as a function of at least one output parameter generated by said simulation unit.

16. The method according to claim 15, wherein transforming at least one provided model input into at least one model output is performed according to said at least one process improvement project by a transformation unit.

17. A computer program product comprising a computer readable medium containing computer program code which when executed on a computer performs the steps according to claim 15.

18. The computer program product according to claim 17, wherein transforming at least one provided model input into at least one model output is performed according to said at least one process improvement project by a transformation unit.
